(19) United States
(12) Patent Application Publication
(10) Pub. No.: US 2022/0308978 A1
(43) Pub. Date: Sep. 29, 2022

(54) TASK SIMULATION USING REVISED GOALS

(71) Applicant: International Business Machines Corporation, Armonk, NY (US)

(72) Inventors: Srinivasan S. Muthuswamy, Bangalore (IN); Mukesh Kumar, BANGALORE (IN); Willie Robert Patten, JR., Hurdle Mills, NC (US); Subhendu Das, Chapel Hill, NC (US)

(21) Appl. No.: 17/210,954

(22) Filed: Mar. 24, 2021

(51) Int. Cl. G06F 11/34

(52) U.S. Cl. CPC G06F 11/3457; G06F 11/3452

(57) ABSTRACT

A processor may receive target data regarding initial targets. The initial targets may relate to specific values for a first set of factors regarding performance of tasks for a first time period. The processor may receive task data regarding the performance of the tasks. The task data may be associated with values for a second set of factors over a second time period. The processor may analyze attributes of the tasks. The processor may generate feature data regarding features of the task. The features may relate to the attributes of the tasks that can be varied to perform the tasks over the second time period. The processor may generate a simulation of the performance of the tasks using the task data and the feature data.

### BACKGROUND

The present disclosure relates generally to the field of task simulation, and more specifically to optimizing features for performance of a task using revised targets.

The generation of a computer simulation of a task may incorporate information about multiple features regarding the performance of the task.

### SUMMARY

Embodiments of the present disclosure include a method, computer program product, and system for optimizing features for performance of a task using revised targets. A processor may receive target data regarding initial targets. The initial targets may relate to specific values for a first set of factors regarding performance of tasks for a first time period. The processor may receive task data regarding the performance of the tasks. The task data may be associated with values for a second set of factors over a second time period. The processor may analyze attributes of the tasks. The processor may generate feature data regarding features of the task. The features may relate to the attributes of the tasks that can be varied to perform the tasks over the second time period. The processor may generate a simulation of the performance of the tasks using the task data and the feature data.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for optimizing features for performance of a task, in accordance with aspects of the present disclosure.

FIG. 2 is a flowchart of an exemplary method system for optimizing features for performance of a task, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of task simulation, and more specifically to optimizing features for performance of a task using revised targets. While the present disclosure is not necessarily limited to such applications, various aspects of the disclosure may be appreciated through a discussion of various examples using this context.

In some embodiments, a processor may receive target data regarding initial targets. In some embodiments, the initial targets may relate to specific values for a first set of factors regarding performance of tasks for a first time period. In some embodiments, the initial targets may be strategic goals for the performance of the tasks over a long-term time period (e.g., one year). In some embodiments, the first set of factors may be key performance indicators for the performance of the tasks. For example, the key performance indicators may include factors such as the quantity of work done, the time taken to perform the work, the quality of the work, or resources utilized to perform the work (e.g., the tasks). In some embodiments, the key performance indicators may be specific values or specific target values for a first set of factors related to quantity, time, quality, or resources (e.g., perform 10% more work each year, improve the accuracy of work by 5% in a year, reduce computing time by 10% during the year, etc.).

In some embodiments, the processor may receive task data regarding the performance of the tasks. In some embodiments, the task data may be associated with values for a second set of factors over a second time period. In some embodiments, the second time period may be less than the first time period. For example, the task data may be values for some of the factors (e.g., quantity of work performed, quality of work performed (e.g., regarding accuracy or other performance metrics), resources utilized to perform the work (e.g., CPU, memory), and time utilized to perform the work) obtained from performance of the tasks on a daily basis. In some embodiments, the second time period may be one or more days. In some embodiments, the task data may include values for factors in the second set of factors for each day in the second time period. For example, the task data may include that over a two-day time period, 10 units of work were done each day, the 10 units of work utilized 32 CPUs and 1 terabit of RAM each day, the 10 units of work were performed with 85% accuracy, and the work took 10 hours of computational time each day to be completed.

In some embodiments, the processor may analyze attributes of the tasks. In some embodiments, the processor may generate feature data regarding features of the task based on the analysis. In some embodiments, the features may relate to the attributes of the tasks that can be varied to perform the tasks over the second time period. In some embodiments, varying the features of the tasks may result in variations of values for the factors over the first time period or over the second time period. For example, the tasks performed may be data management tasks performed for a client. The tasks may include: receiving a first set of data, receiving a second set of data, receiving a third set of data, filtering the first set of data, filtering the second set of data, filtering the third set of data, performing a first transformation function on the first set of data, performing a second transformation function on the first set of data, performing a first transformation function on the second set of data, performing a first transformation function on the third set of data, performing a second transformation function on the third set of data, inputting the first set of data into a first model, utilizing a fourth transformation function on the combined data from the second set of data and the third set of data, inputting the combined data into a second model, applying a fifth transformation function on the outputs of the first model and the second model, inputting the output of the fifth transformation function into a third model, etc. The attributes or features of the tasks that may be varied may include the number of iterations the models perform, the number of features utilized by the transformation functions, the resources utilized for performing the task (e.g., additional nodes) the threshold to filter data, etc.

In some embodiments, the processor may generate a simulation of the performance of the tasks using the task data and the feature data. In some embodiments, the processor may identify each task in a set of tasks. In some embodiments, the processor may identify features of each task that can be varied during the performance of the task. In some embodiments, the computer simulation may include values for features (e.g., number of iterations for each model in the set of tasks) and values for factors (e.g., quantity, quality, resources, time) over the first time period. In some embodiments, the simulation may be able to identify the features of the tasks that may be optimized or compromised as the simulation obtains different permutations or combinations of values for features and values for factors. In some embodiments, the simulation may be generated of the performance of the tasks over the first time period.

For example, by running the simulation it may be determined that when a model runs with 100 iterations, the model is more accurate than when the model utilizes 50 iterations. The simulation may determine that the model's accuracy continues to improve when it uses more iterations from 100 iterations to 300 iterations. The simulation may determine that the accuracy of the model does not improve when a number of iterations greater than 300 are used. In some embodiments, the simulation may also determine how the values for the factors (e.g., quantity, quality, resources, and time) are related. For example, as the quantity of work completed in a certain time period is increased, the quality of the work may deteriorate (e.g., coarser granularity, blurred images, etc.) or the resources needed to perform the work may increase. If the quantity of work is increased, and the time to complete the work is allowed to increase in proportion, the quality of the work and the amount of resources other than time may not need to be increased.

In some embodiments, the processor may generate revised targets. In some embodiments, the revised targets may relate to a revision of specific values for a third set of factors for the first time period. In some embodiments, the revised targets may include a revision to the values for any factor related to the performance of the tasks, including any or all factors in the first set of factors. In some embodiments, the third set of factors may include all factors from the first set of factors. In some embodiments, the values for the revised targets may be percentage variations from the values of the initial goals. For example, the target goal for the quality of a particular model's output may be that the model should have 80% accuracy. The revised target may be that the particular model may have 78% accuracy, 76% accuracy, 74% accuracy, 72% accuracy, or 70% accuracy. In some embodiments, the percentage variations from the initial targets may be predetermined. In some embodiments, a predetermined limit may be applied to the percentage variations (e.g., 20% deviation from initial goals).

In some embodiments, the processor may identify, from the simulation, a set of values for the features. In some embodiments, the set of values may result in performance of the tasks over the first time period complying with the revised targets. In some embodiments, multiple values may be determined for each feature of a particular task. For example, the tasks may include: preprocessing, statistical aggregation (e.g., what is the average claim cost, what is the most common type of accident), inputting the data into a first model, inputting the output of the first model into a second model, and inputting the output of the second model into a third model. In order to comply with the parameters of the revised targets (e.g., regarding factors such as quality, time, resources, etc.), the processor may determine that first model may utilize 100 iterations or 120 iterations. The processor may determine that the second model may run using two GPUs, four GPUs, or eight GPUs, and the processor may determine that the third model may run for two hours, four hours, or six hours. For example, the set of values for the features may be selected from a larger set of values for the features by a selection process. In some embodiments, the selection process may include giving each value an importance score and/or selecting the top N number values for the features. In some embodiments, the number of values for the features that are included in the set of values for the features may be varied by decreasing N or varying the importance score needed to be selected into the set of values for the features.

In some embodiments, the processor may determine the set of values for the features by running the simulation when the resources that are being utilized to perform the tasks are offline. In some embodiments, one or more of set of values for the features may be utilized to perform the tasks so that the simulation that was generated can be compared to the actual perform of the tasks and the accuracy of the simulation confirmed.

In some embodiments, the processor may identify, from the simulation, values for a fourth set of factors that result from the performance of the tasks over the first time period using a first value from the set of values. In some embodiments, the processor may select a value from the set of values for the features. For example, the processor may select that model 1 will run with 100 iterations from the set of values for the features (e.g., 100 or 120 iterations (for model 1), two, four, or eight GPUs (for model 2), and two, four, or six hours of runtime (for model 3). In some embodiments, the first value may be input into the simulation to determine values for factors that result from the performance of the tasks over the first time period using the first value (e.g., the values for time, quality, and resources used over a year based on model 1 running with 100 iterations). In some embodiments, the fourth set of factors may include the same factors as the second set of factors or the first set of factors. In some embodiments, the fourth set of factors may have different factors than the first set of factors and/or the second set of factors.

In some embodiments, the processor may output the first value and the values for the fourth set of factors that result from performance of the tasks over the first time period using the first value. For example, the processor may output that by performing the tasks with the configuration that model 1 performs 100 iterations before determining its output, the key performance indicators for the year will be: performing 5000 units of work, with 70% accuracy, utilizing a runtime of 30 hours a week.

In some embodiments, the processor may select the first value based on a comparison of values for the fourth set of factors and the specific values for the first set of factors. For example, the processor may run the simulation using the first value to determine that the set of factors resulting from performing the tasks for one year using the first value will be: performing 5000 units of work, with 70% accuracy, utilizing a runtime of 30 hours a week. The first set of factors may be goals that during one year: 6000 units of work should be performed (a 20% increase over previous years), with at least 70% accuracy (a 5% improvement over previous years), utilizing a runtime of no more than 25 hours a week (a 20% improvement over previous years). The first value (e.g., model 1 running with 100 iterations) may be selected based on a comparison between values for the fourth set of factors and the specific values for the first set of factors. For example, the comparison may involve computing how much the values for each factor in the fourth set of factors differed (e.g., deviated as a percentage) from the values for each factor in the first set of factors (e.g., related to the initial targets).

In some embodiments, the processor may identify, from the simulation, values for a fifth set of factors that result from the performance of the tasks over the second time period using a first value from the set of values. For example, the processor may determine that when model 1 utilizes 100 iterations, the values for the factors on a daily basis may be: 4 CPUs are utilized, 2 GB of RAM are utilized, the runtime is 6 hours a day, and 20 units of work are performed daily. In some embodiments, the fifth set of factors may be the same set of factors as the fourth set of factors, the third set of factors, the second set of factors, or the first set of factors. In some embodiments, the fifth set of factors may have different factors than the first set of factors, the second set of factors, the third set of factors, and/or the fourth set of factors.

In some embodiments, the processor may identify, from the simulation, values for a sixth set of factors that result from the performance of the tasks over the first time period using a second value from the set of values. In some embodiments, the processor may output the second value and the values for the sixth set of factors that result from performance of the tasks over the first time period using the second value. For example, the processor may select that model 2 utilizes 4 GPUs as the second value. The processor may determine values for a sixth set of factors that result from selection of 4 GPUs to be utilized by model 2. The values for the sixth set of factors may be performing 5200 units of work, with 70% accuracy, utilizing a runtime of 30 hours a week. In some embodiments, the sixth set of factors may include the same factors as the first through fifth sets of factors. In some embodiments, the sixth set of factors may have different factors than any of the first through fifth sets of factors.

In some embodiments, the processor may select the second value based on a comparison of values for the sixth set of factors and the specific values for the first set of factors. For example, the processor may run the simulation using the second value to determine that the set of factors resulting from performing the tasks for one year using the second value will be: performing 5200 units of work, with 70% accuracy, utilizing a runtime of 30 hours a week. The first set of factors may be targets that during one year: 6000 units of work should be performed (a 20% increase over previous years), with at least 70% accuracy (a 5% improvement over previous years), utilizing a runtime of no more than 25 hours a week (a 20% improvement over previous years). The second value (e.g., model 2 running on 4 GPUs) may be selected based on a comparison between values for the sixth set of factors and the values for the first set of factors. For example, the comparison may involve computing how much the values for each factor in the sixth set of factors differ (e.g., percentage deviation) from the values for each factor in the first set of factors (e.g., related to the initial targets).

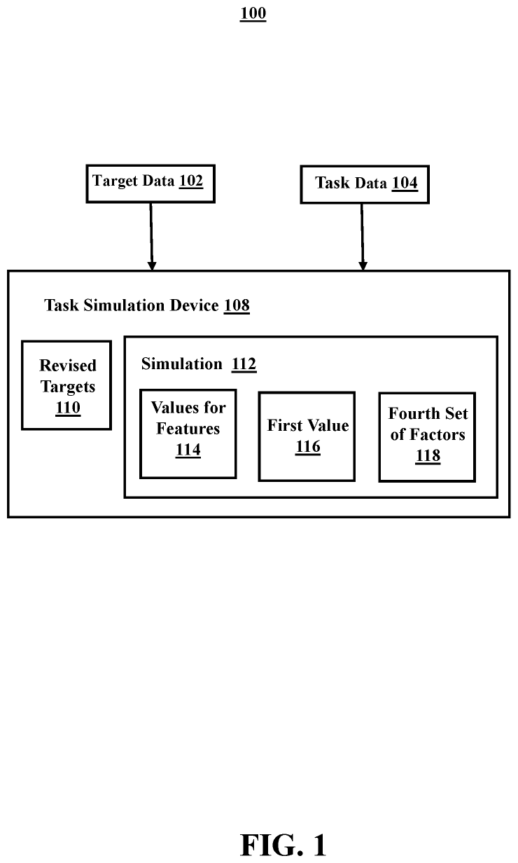

Referring now to FIG. 1, a block diagram of a system 100 for optimizing features of a task using revised goals is illustrated. System 100 includes target data 102, task data 104, and a task simulation device 108. The cooperative driving system 108 is configured to receive the target data 102 and task data 104. The task simulation device 108 includes revised targets 110 and a simulation 112.

The task simulation device 108 analyzes attributes of the tasks and generates feature data regarding features of the task based on the analysis. The task simulation device 108 includes simulation 112 that is a simulation of the tasks created using the task data and the feature data. The revised targets 110 are values for a third set of factors for a first time period and are determined based on the target data 102 received regarding initial targets. Based on the simulation 112, a set of values for the features 114 is identified. The set of values for the features 114 result in performance of the tasks over the first time period complying with the revised targets. A first value 116 is selected from the set of values for features 114. The values for the fourth set of factors 118 that result from the performance of the tasks over the first timer period using the first value 116 are identified. The first value 116 and the fourth set of factors 118 are output to a user device (not shown) where they are utilized by the user to optimize performance of the tasks.

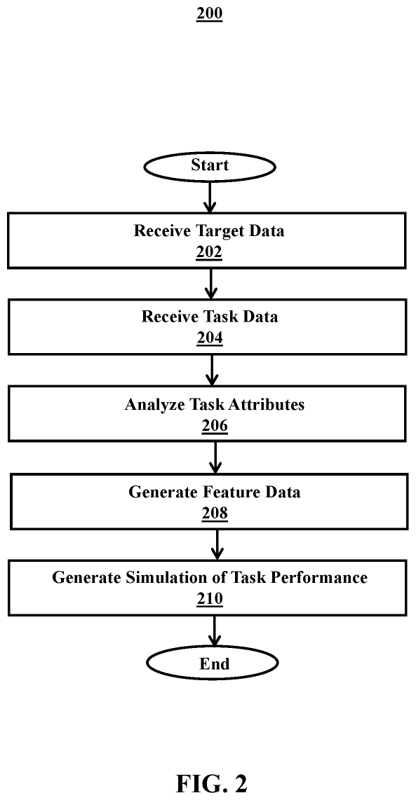

Referring now to FIG. 2, illustrated is a flowchart of an exemplary method 200 for optimizing features of a task using revised goals, in accordance with embodiments of the present disclosure. In some embodiments, a processor of a system may perform the operations of the method 200. In some embodiments, method 200 begins at operation 202. At operation 202, the processor receives target data regarding initial targets. In some embodiments, the initial targets relate to specific values for a first set of factors regarding performance of tasks for a first time period. In some embodiments, method 200 proceeds to operation 204, where the processor receives task data regarding the performance of the tasks. In some embodiments, the task data is associated with values for a second set of factors over a second time period. In some embodiments, method 200 proceeds to operation 206. At operation 206, the processor analyzes attributes of the tasks. In some embodiments, method 200 proceeds to operation 208. At operation 208, the processor generates feature data regarding features of the task. In some embodiments, the features relate to the attributes of the tasks that can be varied to perform the tasks over the second time period. In some embodiments, method 200 proceeds to operation 210. At operation 210, the processor generates a simulation of the performance of the tasks using the task data and the feature data.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

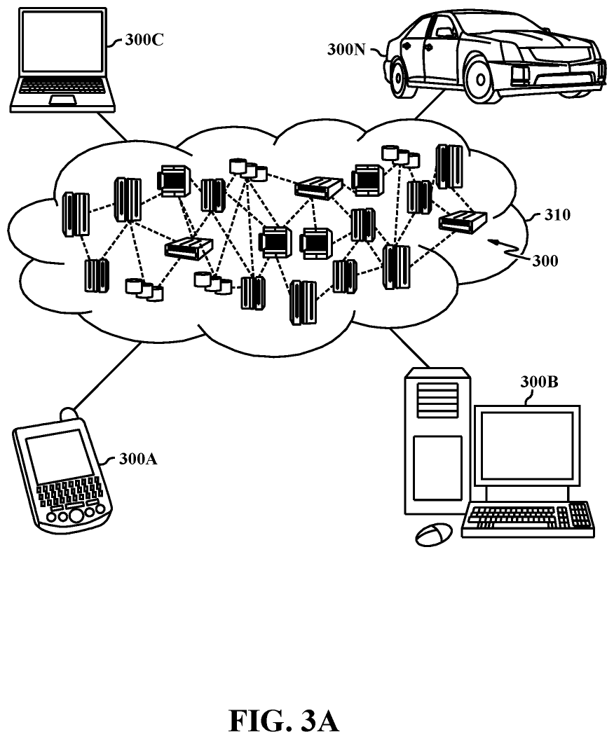

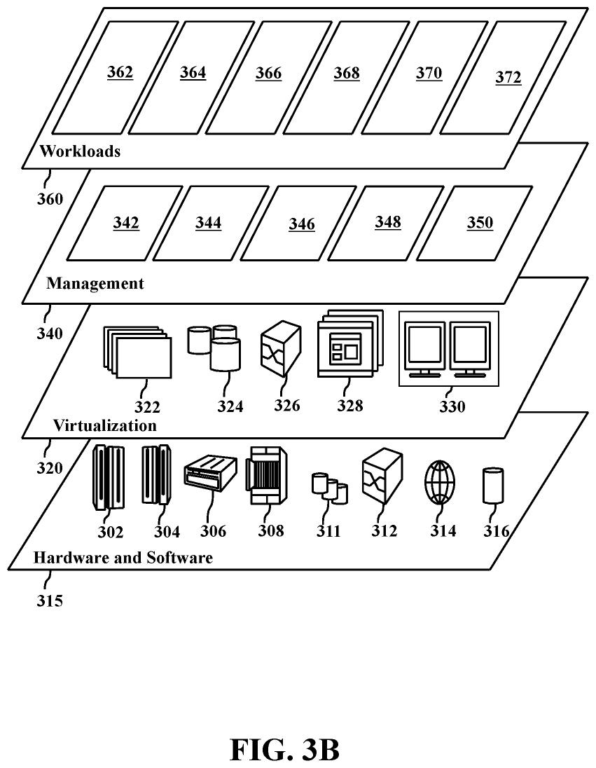

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and optimizing features for performance of a task using revised targets 372.

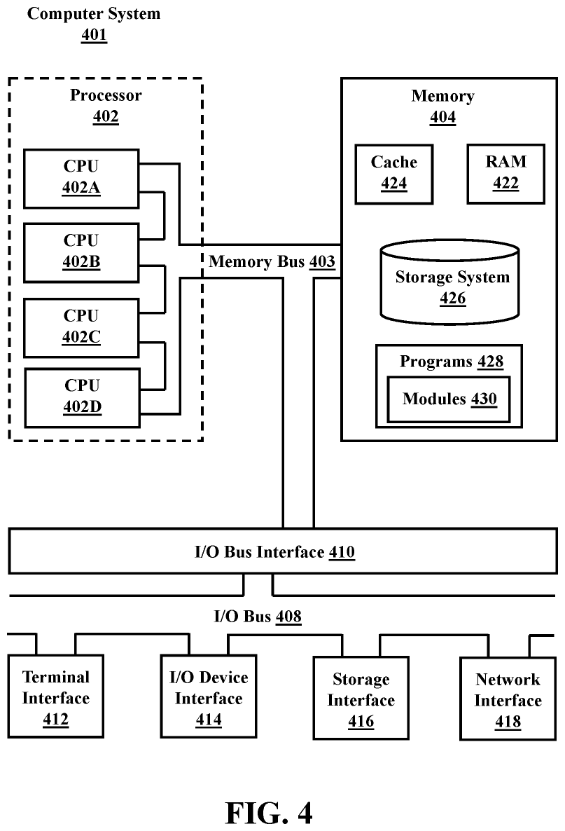

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, target data regarding initial targets, wherein the initial targets relate to specific values for a first set of factors regarding performance of tasks for a first time period;
receiving task data regarding the performance of the tasks, wherein the task data is associated with values for a second set of factors over a second time period;
analyzing attributes of the tasks;
generating feature data regarding features of the task, wherein the features relate to the attributes of the tasks that can be varied to perform the tasks over the second time period; and
generating a simulation of the performance of the tasks using the task data and the feature data.

2. The method of claim 1, further comprising:
generating revised targets, wherein the revised targets relate to a revision of specific values for a third set of factors for the first time period; and
identifying, from the simulation, a set of values for the features, wherein the set of values result in performance of the tasks over the first time period complying with the revised targets.

3. The method of claim 2, further comprising:
identifying, from the simulation, values for a fourth set of factors that result from the performance of the tasks over the first time period using a first value from the set of values; and
outputting the first value and the values for the fourth set of factors that result from performance of the tasks over the first time period using the first value.

4. The method for claim 3, wherein the first value is selected based on a comparison of values for the fourth set of factors and the specific values for the first set of factors.

5. The method of claim 3, further comprising:
identifying, from the simulation, values for a fifth set of factors that result from performance of the tasks over the second time period using the first value from the set of values.

6. The method of claim 3, further comprising:
identifying, from the simulation, values for a sixth set of factors that result from the performance of the tasks over the first time period using a second value from the set of values;
outputting the second value and the values for the sixth set of factors that result from performance of the tasks over the first time period using the second value.

7. The method for claim 6, wherein second value is selected based on a comparison of values for the sixth set of factors and the specific values for the first set of factors.

8. A system comprising:
a memory; and
a processor in communication with the memory, the processor being configured to perform operations comprising:
receiving target data regarding initial targets, wherein the initial targets relate to specific values for a first set of factors regarding performance of tasks for a first time period;
receiving task data regarding the performance of the tasks, wherein the task data is associated with values for a second set of factors over a second time period;
analyzing attributes of the tasks;
generating feature data regarding features of the task, wherein the features relate to the attributes of the tasks that can be varied to perform the tasks over the second time period; and
generating a simulation of the performance of the tasks using the task data and the feature data.

9. The system of claim 8, the processor being further configured to perform operations comprising:
generating revised targets, wherein the revised targets relate to a revision of specific values for a third set of factors for the first time period; and
identifying, from the simulation, a set of values for the features, wherein the set of values result in performance of the tasks over the first time period complying with the revised targets.

10. The system of claim 9, the processor being further configured to perform operations comprising:
identifying, from the simulation, values for a fourth set of factors that result from the performance of the tasks over the first time period using a first value from the set of values; and
outputting the first value and the values for the fourth set of factors that result from performance of the tasks over the first time period using the first value.

11. The system for claim 10, wherein the first value is selected based on a comparison of values for the fourth set of factors and the specific values for the first set of factors.

12. The system of claim 10, the processor being further configured to perform operations comprising:
identifying, from the simulation, values for a fifth set of factors that result from performance of the tasks over the second time period using the first value from the set of values.

13. The system of claim 10, the processor being further configured to perform operations comprising:
identifying, from the simulation, values for a sixth set of factors that result from the performance of the tasks over the first time period using a second value from the set of values;
outputting the second value and the values for the sixth set of factors that result from performance of the tasks over the first time period using the second value.

14. The system for claim 13, wherein second value is selected based on a comparison of values for the sixth set of factors and the specific values for the first set of factors.

15. A computer program product comprising a computer readable storage medium having program instructions embodied therewith, the program instructions executable by a processor to cause the processor to perform operations, the operations comprising:
receiving target data regarding initial targets, wherein the initial targets relate to specific values for a first set of factors regarding performance of tasks for a first time period;
receiving task data regarding the performance of the tasks, wherein the task data is associated with values for a second set of factors over a second time period;
analyzing attributes of the tasks;
generating feature data regarding features of the task, wherein the features relate to the attributes of the tasks that can be varied to perform the tasks over the second time period; and
generating a simulation of the performance of the tasks using the task data and the feature data.

16. The computer program product of claim 15, the processor being further configured to perform operations comprising:
generating revised targets, wherein the revised targets relate to a revision of specific values for a third set of factors for the first time period; and
identifying, from the simulation, a set of values for the features, wherein the set of values result in performance of the tasks over the first time period complying with the revised targets.

17. The computer program product of claim 16, the processor being further configured to perform operations comprising:
identifying, from the simulation, values for a fourth set of factors that result from the performance of the tasks over the first time period using a first value from the set of values; and
outputting the first value and the values for the fourth set of factors that result from performance of the tasks over the first time period using the first value.

18. The computer program product for claim 17, wherein the first value is selected based on a comparison of values for the fourth set of factors and the specific values for the first set of factors.

19. The computer program product of claim 17, the processor being further configured to perform operations comprising:
identifying, from the simulation, values for a fifth set of factors that result from performance of the tasks over the second time period using the first value from the set of values.

20. The computer program product of claim 17, the processor being further configured to perform operations comprising:
identifying, from the simulation, values for a sixth set of factors that result from the performance of the tasks over the first time period using a second value from the set of values;
outputting the second value and the values for the sixth set of factors that result from performance of the tasks over the first time period using the second value.
